(19) United States
(12) Patent Application Publication
(10) Pub. No.: US 2022/0053396 A1
(43) Pub. Date: Feb. 17, 2022

(54) WIRELESS COMMUNICATION QUALITY VISUALIZING DEVICE AND WIRELESS COMMUNICATION QUALITY VISUALIZING SYSTEM

(71) Applicant: NEC Corporation, Minato-ku, Tokyo (JP)

(72) Inventors: Shinichi ANAMI, Tokyo (JP); Takamichi INOUE, Tokyo (JP)

(73) Assignee: NEC Corporation, Minato-ku, Tokyo (JP)

(21) Appl. No.: 17/435,781

(22) PCT Filed: Jan. 30, 2020
(86) PCT No.: PCT/JP2020/003498

§ 371 Date: Sep. 2, 2021

(30) Foreign Application Priority Data
Mar. 8, 2019 (JP) 2019-042494

(51) Int. Cl. H04W 36/06; H04W 72/04; H04B 17/23; H04B 17/309; H04B 17/391; H04W 16/18; H04W 24/08

(52) U.S. Cl. CPC H04W 36/06; H04W 72/0453; H04B 17/23; H04W 24/08; H04B 17/391; H04W 16/18; H04B 17/309

(57) ABSTRACT

A wireless communication quality visualizing device includes a display data generating unit which generates display data for displaying the communication quality from data on the communication quality collected by the multiple measurement devices in accordance with a measurement condition which can specify information for measuring the communication quality, a position determining unit which determines whether or not the measurement device has moved and for estimating a position of the measurement device after the movement, and a condition setting unit which changes the measurement condition when the position determining-unit determines that the measurement device has moved.

### TECHNICAL FIELD

The present invention relates to a wireless communication quality visualizing device and a wireless communication quality visualizing system that enable visual display of communication quality in a predetermined wireless communication environment.

### TECHNICAL FIELD

As a system for evaluating the communication quality (wireless communication quality) of a wireless LAN (Local Area Network) that includes multiple access points (APs: Access Points), there is a system in which multiple measurement devices (capture devices) are used (for example, refer to patent literature 1). Each of the capture devices is installed at each of multiple points in the wireless LAN environment. The data captured by each capture device is analyzed by a communication quality information generating device.

In the system described in patent literature 1, the communication quality information generating device performs analysis using the data from each capture device that has successfully received the data transmitted from a terminal. Thus, the communication quality of a wide range of wireless LAN environments can be evaluated. The number of total transmission frames, the number of transmission retries, the average transmission rate, and the maximum transmission rate are used as the communication quality. The communication quality information generating device includes a display unit. The display unit visually displays the communication quality of the wireless LAN environment and other information based on the data received by the capture device.

Patent literature 2 describes a radio wave condition management system including a mobile communication terminal, a server, and a viewing terminal. The server collects radio wave condition from mobile communication terminals and maps the radio wave condition on a map. The viewing terminal requests the map with the radio wave condition mapped to the server. The viewing terminal displays the map (the radio wave condition mapped on it) that the server transmits in response to the request.

When the wireless communication quality, etc., is visually displayed in time series, it becomes possible to grasp the actual usage condition, etc., in time series. In addition, when the time series of wireless communication quality, etc., is visually displayed, it becomes easier to estimate the cause of communication interruption, data transfer delay, etc.

### CITATION LIST

### Patent Literature

Patent literature 1: Japanese Patent Laid-Open No. 2017-169003
Patent literature 2: Japanese Patent Laid-Open No. 2004-214875

### SUMMARY OF INVENTION

### Technical Problem

However, if the system described in patent literature 1 is modified so that the time series of the radio communication quality is displayed visually, the displayed radio communication quality may be inaccurate when the capture device is moved artificially. This is because the displayed wireless communication quality will be different from the actual wireless communication quality in the actual wireless communication environment. In addition, there is a possibility that the capture device may be moved due to layout changes in the space where the capture device is installed.

If the capture device acquires data at a position different from the assumed position, a received signal strength indicator (RSSI) distribution different from the actual one will be visually displayed. In such a case, the administrator or others who see the display may take measures that are not necessary, such as moving the AP.

The same problem arises when the system described in patent literature 1 is not modified so that the time series of radio communication quality, etc., is displayed visually.

Furthermore, if the frequency of the radio waves emitted from the AP is changed due to operational changes or automatic adjustment functions such as DFS (Dynamic Frequency Selection), the capture device may not be able to acquire data, making it impossible to visualize radio quality, etc.

It is an object of the present invention to provide a wireless communication quality visualizing device and a wireless communication quality visualizing system that can maintain the condition of visual display of wireless quality, etc. with high accuracy even when changes occur in the wireless communication environment.

### Solution to Problem

A wireless communication quality visualizing device according to the present invention is a device that visually displays communication quality in a wireless communication environment where multiple measurement devices are installed, wherein the device includes display data generating means for generating display data for displaying the communication quality from data on the communication quality collected by the multiple measurement devices in accordance with a measurement condition which can specify information for measuring the communication quality, position determining means for determining whether or not the measurement device has moved and for estimating a position of the measurement device after the movement, and condition setting means for changing the measurement condition when the position determining means determines that the measurement device has moved.

A measurement device according to the present invention is a device that is communicatively connected to a wireless communication quality visualizing device that visually displays communication quality in a wireless communication environment, wherein the device includes data collection means for collecting data on communication quality in accordance with a measurement condition which can specify information for measuring the communication quality, and data transmission means for transmitting the data collected by the data collection means to the wireless communication quality visualizing device, wherein the measurement condition includes at least information indicating a frequency band to be monitored among multiple frequency bands that can be used in the wireless communication environment, and the measurement device further comprises change detection means for deciding to change the frequency band to be monitored when a condition for changing a monitoring target is satisfied.

A wireless communication quality visualizing system according to the present invention is a system that visually displays the communication quality in a wireless communication environment where multiple measurement devices are installed, wherein the system includes a wireless communication quality visualizing device including; display data generating means for generating display data for displaying the communication quality from data on the communication quality collected by the multiple measurement devices in accordance with a measurement condition which can specify information for measuring the communication quality, position determining means for determining whether or not the measurement device has moved and for estimating a position of the measurement device after the movement, and condition setting means for changing the measurement condition when the position determining means determines that the measurement device has moved, wherein each of the multiple measurement devices includes; data collection means for collecting data on communication quality in accordance with the measurement condition, and data transmission means for transmitting the data collected by the data collection means to the wireless communication quality visualizing device.

A wireless communication quality visualizing method according to the present invention is a method that visually displays communication quality in a wireless communication environment where multiple measurement devices are installed, wherein the method includes collecting data on communication quality in accordance with a measurement condition which can specify information for measuring the communication quality, generating display data for displaying the communication quality from collected data on the communication quality, determining whether or not the measurement device has moved and estimating a position of the measurement device after the movement, and changing the measurement condition when it is determined that the measurement device has moved.

Another aspect of a wireless communication quality visualizing method according to the present invention is a method that visually displays communication quality in a wireless communication environment where multiple measurement devices are installed, wherein the method includes collecting data on communication quality in accordance with a measurement condition which can specify information for measuring the communication quality, and generating display data for displaying the communication quality from collected data on the communication quality, wherein the measurement condition includes at least information indicating a frequency band to be monitored among multiple frequency bands that can be used in the wireless communication environment, and the wireless communication quality visualizing method further includes changing the frequency band to be monitored when a condition for changing a monitoring target is satisfied.

### Advantageous Effects of Invention

According to this invention, it is possible to maintain the condition of visual display of wireless quality, etc. with high accuracy even when changes occur in the wireless communication environment.

### BRIEF DESCRIPTION OF DRAWINGS

FIG. 1 It depicts a block diagram showing a configuration example of a wireless communication quality visualizing system including a server.

FIG. 2 It depicts a block diagram showing a configuration example of a sensor.

FIG. 3 It depicts a block diagram showing a configuration example of a server.

FIG. 4 It depicts a flowchart showing an operation of a sensor.

FIG. 5 It depicts a flowchart showing an operation of a server.

FIG. 6 It depicts an explanatory diagram showing an example of the measurement environment.

FIG. 7 It depicts an explanatory diagram showing an example of a location where a sensor is installed.

FIG. 8 It depicts an explanatory diagram showing a display example in a viewing terminal.

FIG. 9 It depicts an explanatory diagram showing an example of a location where a sensor exists after the movement.

FIG. 10 It depicts an explanatory diagram showing a display example in a viewing terminal.

FIG. 11 It depicts an explanatory diagram to explain how to estimate a position of a sensor after the movement and how to take measures.

FIG. 12 It depicts a block diagram showing an example of a computer having a CPU.

FIG. 13 It depicts a block diagram showing the main part of a wireless communication quality visualizing system.

FIG. 14 It depicts a block diagram showing the main part of a measurement device.

FIG. 15 It depicts a block diagram showing the main part of a wireless communication quality visualizing system.

### DESCRIPTION OF EMBODIMENTS

Hereinafter, example embodiment of the present invention is described with reference to the drawings.

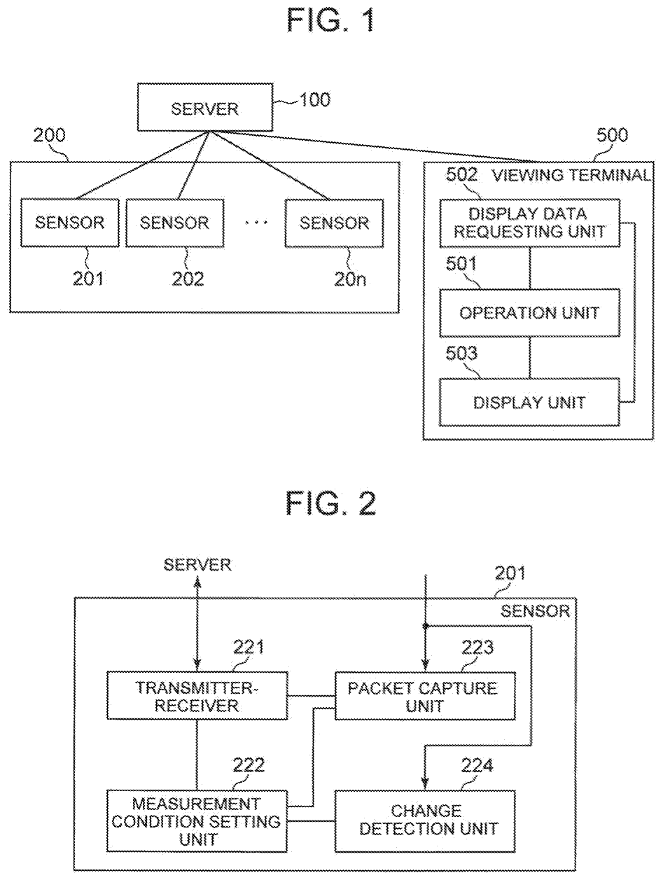

FIG. 1 is a block diagram showing a configuration example of a wireless communication quality visualizing system that includes a server corresponding to a wireless communication quality visualizing device.

The wireless communication quality visualizing system shown in FIG. 1 includes multiple sensors (measurement devices) 201-20n installed in a predetermined wireless communication environment 200. The sensors 201-20n are capable of communicating with the server 100. The wireless communication environment 200 has multiple APs and multiple STAs (Stations: Terminals) (not shown in FIG. 1).

When the server 100 is a cloud server, the server 100 communicates with the sensors 201-20n through a Long Term Evolution (LTE) line and an Internet network, for example. When the server 100 is an on-premise server, the server 100 communicates with the sensors 201-20n through a private communication network, for example.

There is also a viewing terminal 500 that can communicate with the server 100. For example, a personal computer or a mobile information terminal can be used as the viewing terminal 500.

The viewing terminal 500 includes an operation unit 501, a display data requesting unit 502, and a display unit 503. When a request for data to display the wireless condition is input by the operator through the operation unit 501, the display data requesting unit 502 requests the data from the server 100. The display unit 503 displays based on the data downloaded from the server 100.

FIG. 2 is a block diagram showing a configuration example of a sensor. FIG. 2 shows an example configuration of sensor 201, but sensors 202-20n are also configured in the same way as sensor 201.

However, among the sensors 201-20n, there may be sensors that capture packets and sensors that collect information to generate RSSI distributions, separately. In addition, among the sensors 201-20n, there may be sensors that monitor a specific frequency band and other sensors that monitor multiple frequency bands. Note that “monitoring” means checking the status of the frequency band in which the packet is captured.

In the example shown in FIG. 2, the sensor 201 includes a transmitter-receiver 221, a measurement condition setting unit 222, a packet capture unit 223, and a change detection unit 224.

The transmitter-receiver 221 communicates with the server 100. The measurement condition setting unit 222 holds data (set values) representing a measurement condition or measurement requirement for monitoring the wireless conditions in the wireless communication environment 200. The packet capture unit 223 captures packets transmitted and received in the wireless communication environment 200, based on the set values. The packets captured by the packet capture unit 223 may be stored in a storage unit (not shown) at the sensor 201. The change detection unit 224 detects a change in the frequency band to be monitored.

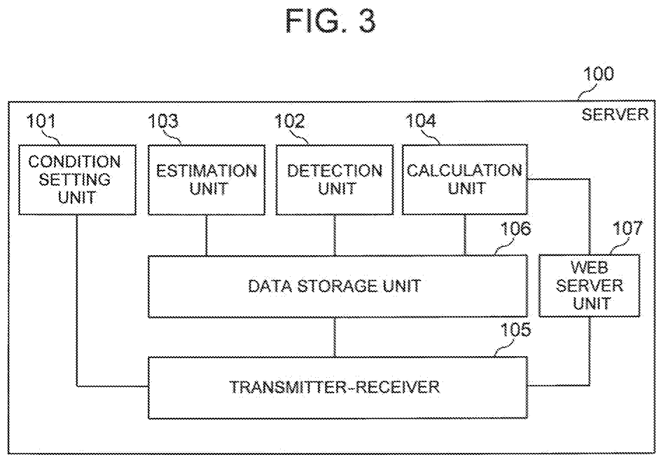

FIG. 3 is a block diagram showing a configuration example of a server. In the example shown in FIG. 3, the server 100 includes a condition setting unit 101, a detection unit 102, an estimation unit 103, a calculation unit 104, a transmitter-receiver 105, a data storage unit 106, and a web server unit 107.

The condition setting unit 101 changes the measurement condition. The condition setting unit 101 manages position information of sensors 201-20n.

The measurement condition is a condition under which information for measuring the communication quality in the wireless communication environment 200 can be specified.

Specifically, the measurement condition includes at least a frequency band to be monitored and monitoring time for each frequency band. The items included in the measurement condition are not limited to those, and other items may also be included.

The detection unit 102 determines whether or not a position of each of sensors 201-20n has been changed. The estimation unit 103 estimates a position of each of sensors 201-20n after being changed, when at least one of the positions of the sensors 201-20n has been changed. The calculation unit 104 calculates an index (for example, RSSI distribution) regarding the wireless communication environment.

The transmitter-receiver 105 communicates with sensors 201-20n and the viewing terminal 500. The data storage unit 106 stores data (captured packets, etc.) received by the transmitter-receiver 105 from the sensors 201-20n. The web server unit 107 generates display data regarding the wireless communication environment (hereinafter, referred to as a web page) and supplies the web page to the viewing terminal 500 upon request. The display data regarding the communication environment includes data representing the RSSI distribution.

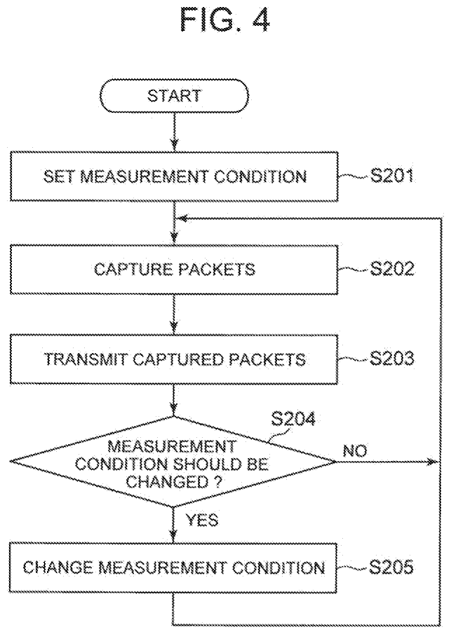

Next, the operation of sensor 201 is described with reference to the flowchart of FIG. 4. Sensors 202-20n also operate in the same way as sensor 201.

A frequency band to be monitored is set in the sensor 201 as a measurement condition (step S201). The frequency band is 52 ch, 56 ch, 60 ch, or 64 ch of wireless LAN, for example. The measurement condition is stored in the measurement condition setting unit 222. The measurement condition is set, for example, directly by hand or by the server 100. When there are multiple frequency bands to be monitored (frequency bands included in the measurement condition) and each frequency band is monitored in time division, the monitoring time (for example, 15 seconds) for each frequency band is also set to the measurement condition.

After that, the sensor 201 repeatedly executes the process of steps S202 to S205.

In step S202, the packet capture unit 223 captures packets transmitted and received between the AP and the STA according to the measurement condition set in step S201. If the measurement condition includes a monitoring time, the packet capture unit 223 captures packets transmitted during the monitoring time.

The packet capture unit 223 adds time information indicating the time of capture to the captured packets.

The transmitter-receiver 221 transmits the packets captured by the packet capture unit 223 to the server 100 (step S203). The packet capture unit 223 may store the captured packets in the packet storage unit, and the transmitter-receiver 221 may transmit the packets stored in the storage unit to the server 100 at once every time a predetermined time passes.

The change detection unit 224 checks whether the measurement condition should be changed or not (step S204). If a condition occurs in which the measurement condition should be changed, the measurement condition is changed (step S205). The measurement condition setting unit 222 stores the measurement condition after being changed.

When the sensor 201 receives the changed measurement condition from the server 100, the measurement condition setting unit 222 updates the stored measurement condition with the received measurement condition.

The case in which the measurement condition should be changed and the process of changing the measurement condition are as follows, for example.

If a specific frequency band has been set in the measurement condition setting unit 222 as the measurement condition, the change detection unit 224 will set the measurement condition to the frequency band after the change when it detects that the frequency band has changed.

For example, suppose that the sensor 201 is assigned the role of monitoring a radio wave from a specific AP. The specific AP can emit a radio wave in one or more frequency bands. When the sensor 201 receives a radio wave in a frequency band other than one or more of these bands, the measurement condition is changed, assuming that the frequency band used by the specific AP has been changed.

If the sensor 210 is assigned the role of monitoring one frequency band used by a specific AP, the change detection unit 224 scans all frequency bands used when the changed frequency band cannot be immediately identified. Then, the change detection unit 224 identifies the changed frequency band based on the BSSID (Basic Service Set Identifier) of a specific AP, etc.

The change detection unit 224 may also determine that the frequency band has changed when the amount of packets captured in the frequency band being monitored falls below a predetermined threshold value. The threshold value is, for example, the amount of past packets captured during a predetermined time period during the operating time of the wireless communication environment 200 (for example, when the wireless communication environment 200 is located in a factory, the factory is in operation). Specifically, for example, the threshold value is an average value of the past packet volume. The change detection unit 224 compares the amount of packets captured during the predetermined time period with the threshold value.

Although the change detection unit 224 may change the detection condition immediately when determining that the frequency band has changed using the threshold value, the sensor 201 may generate an alarm. In response to the alarm, an administrator or the like can check the status of the AP or the like that was using the frequency band being monitored. In that case, a modified detection condition is set to the measurement condition setting unit 222 by the administrator or the like.

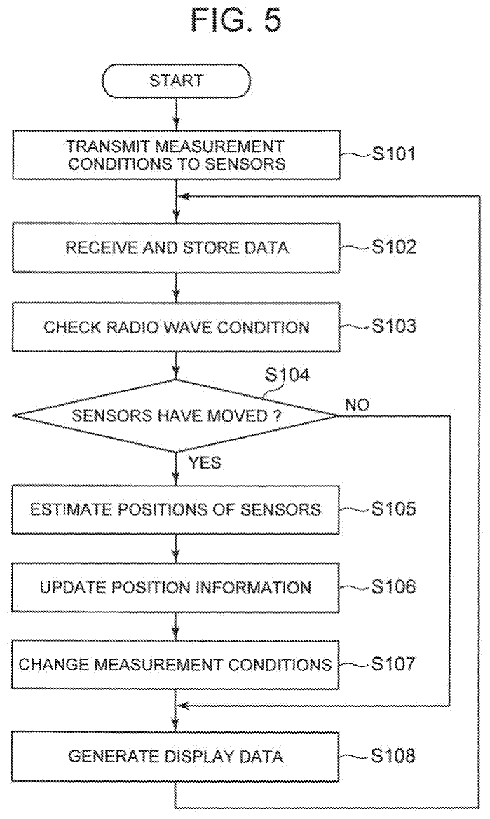

Next, the operation of the server 100 will be described with reference to the flowchart of FIG. 5.

The server 100 transmits the measurement condition to each sensor 201-20n (step S101). Specifically, the server 100 transmits the initial set value of the measurement condition. If the measurement condition is installed on the side of the sensors 201-20n, for example, manually, the process of step S101 is unnecessary. Thereafter, the server 100 repeatedly executes the process of steps S101 to S108.

In step S102, when the transmitter-receiver 105 receives data from each sensor 201-20n, the transmitter-receiver 105 stores the data in the data storage unit 106 (step S102). The data is packets or the like captured by each sensor 201-20n. The server 100 then checks the radio wave condition of the wireless communication environment 200 (step S103).

Specifically, in the process of step S103, the detection unit 102 checks whether the sensors 201-20n have moved or not.

Once it is checked that the sensors 201-20n have moved (step S104), the estimation unit 103 estimates positions of the sensors 201-20n after the movement (step S105). The condition setting unit 101 regards the position estimated by the estimation unit 103 as the position after the movement. Therefore, the condition setting unit 101 updates the stored position with the position estimated by the estimation unit 103 (step S106).

In addition, the condition setting unit 101 changes the measurement conditions of sensors 201-20n after the movement (step S107). For example, focusing on sensor 201, when the sensor 201 monitors a frequency band of 56 ch, and the frequency band used by the nearest AP at the position after the movement is 52 ch, the frequency band included in the measurement condition is changed to 52 ch. Then, the condition setting unit 101 transmits the changed measurement condition to the sensor 201 through the transmitter-receiver 105.

The calculation unit 104 generates display data for displaying the data stored in the data storage unit 106, i.e., the data received from the sensors 201-20n (specifically, the RSSI added to the captured packets) (step S108). Then, the web server unit 107 generates and publishes a web page based on the display data. The web page is a map on which the RSSI distribution is mapped, for example.

It is preferable that the web page may also include information indicating the positions of the APs present in the wireless communication environment 200 (for example, icons displayed at the positions where the APs are present). Furthermore, information regarding the positions of sensors 201-20n may also be included in the web page.

With respect to RSSI, only the data at the installation points of sensors 201-20n exist. Therefore, the calculation unit 104 generates data of RSSI in the space of the wireless communication environment 200 by an interpolation process using the data at the installation points of the sensors 201-20n.

As explained above, in this example embodiment, the sensors 201-20n automatically change the frequency band to be monitored when the frequency band to be monitored is changed. In addition, since the server 100 changes the measurement condition according to the position after the movement when the server 100 detects the movement of the sensors 201-20n, the situation of visual display of wireless quality, etc. with high accuracy is maintained even when changes occur in the wireless communication environment. As a result, when constantly monitoring the wireless communication quality, when the measurement condition (position, frequency, etc.) is changed, the setting change and maintenance work becomes easy or unnecessary.

In this example embodiment, both the change in the frequency band to be monitored and the change in the position of the sensors 201-20n are monitored, but only one of them may be monitored.

In this example embodiment, the server 100 detects changes in the position of the sensors 201-20n, and each sensor 201-20n detects changes in the frequency band, but the division of roles regarding position detection and frequency band change detection is not limited to that. As an example, the server 100 may have a function regarding the detection of changes in frequency band.

The wireless communication quality visualizing system of this example embodiment is suitably used in industries such as the manufacturing industry, where interruption or instability in communication can cause major disruptions to business operations. The wireless communication quality visualizing system of this example embodiment can also be applied to other industries where the wireless penetration rate is low or uses of wireless are limited. The wireless communication quality visualizing system of this example embodiment can also be used as a mechanism for operation management and maintenance when a new wireless system is introduced. In addition, this wireless communication quality visualizing system is not limited to the manufacturing industry, but is expected to be applied to sites such as transportation (warehousing), construction, and medical care. Note that the application to those is just one example, and the application of the wireless communication quality visualizing system of this example embodiment is not limited to those.

### Example

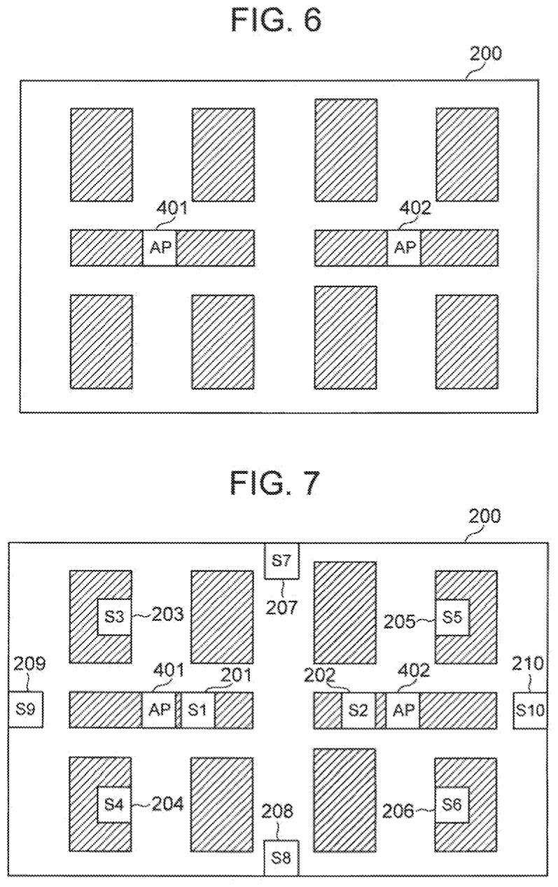

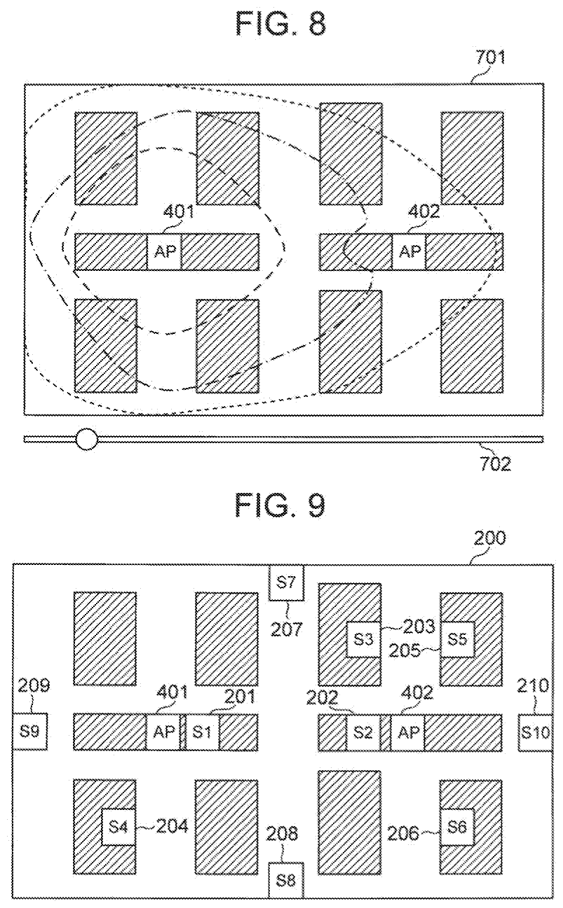

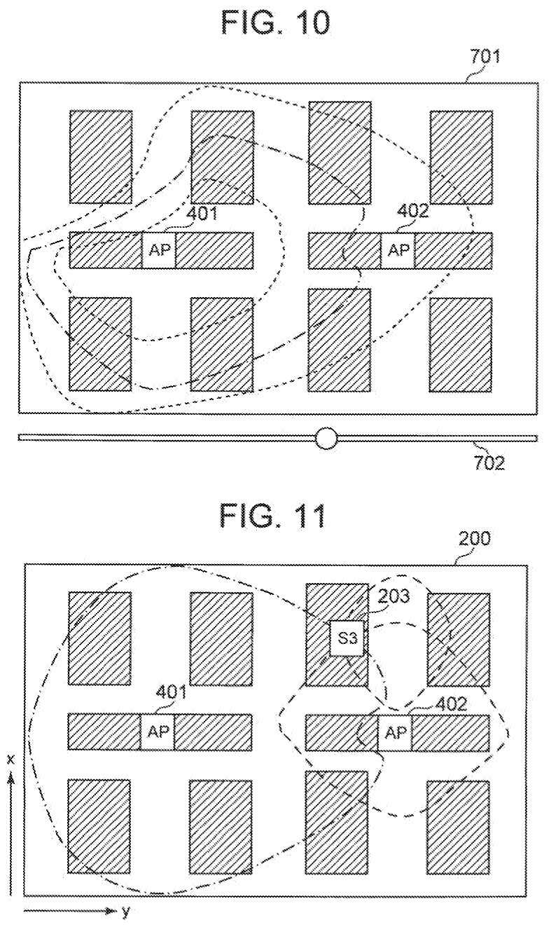

The specific examples are described below with reference to the explanatory figures in FIGS. 6 to 11. FIG. 6 is an explanatory diagram showing an example of the measurement environment. FIG. 7 is an explanatory diagram showing an example of a location where sensors 201-20n are installed. FIG. 8 and FIG. 10 are explanatory diagrams showing display examples in the display area in the viewing terminal 500. FIG. 9 is an explanatory diagram showing an example of a location where a sensor exists after the movement. FIG. 11 is an explanatory diagram to explain how to estimate a position of sensors 201-20n after the movement. In FIGS. 8 and 10, along with the display area 701, an indicator 702 showing the passage of time is also shown.

In the example shown in FIG. 6, two APs 401 and 402 are installed on a ceiling or the like in a wireless communication environment 200. In this example, assume that the AP401 uses 52 ch, and the AP402 uses 56 ch. In FIGS. 6 to 11, the shaded rectangles indicate structures (for example, desks, shelves, cabinets, equipment). As shown in FIG. 7, the case where 10 sensors 201-210 are installed is taken as an example.

Among the sensors 201-210, sensors 201 and 202 are installed on a shelf in the vicinity of APs 401 and 402 to capture all packets transmitted and received by APs 401 and 402. Sensors 203-206 are assumed to be installed on a workbench or other location in the vicinity of the STA (not shown) in order to capture packets transmitted and received by the STA. Sensors 207-210 are installed on a wall or other location at a reasonable distance from other sensors 201-206 in order to generate RSSI distribution. The sensors 207-210 capture packets in multiple frequency bands.

In other words, in this example, multiple sensors with different roles are installed. Therefore, among the sensors 201-210, there are multiple sensors with different initial values of measurement conditions.

In FIGS. 8 and 10, curves (dashed, dotted, and single-dotted lines) showing equal RSSI are illustrated in the display area 701. In the following, the curve connecting equal RSSI (shown as a contour-like curve), as illustrated in FIGS. 8 and 10, is called radio wave condition. The radio wave condition may also be expressed using electric field strength distribution.

The sensor 201 captures packets in the frequency band of 52 ch used by AP 401 for transmission and reception for 60 seconds according to the set measurement condition, and transmits the captured packets to the server 100. The sensor 202 captures packets in the 56 ch frequency band used by AP 402 for transmission and reception for 60 seconds according to the set measurement condition, and transmits the captured packets to the server 100.

The sensors 203, 204 capture packets in the frequency band of 52 ch for 50 seconds and packets in the frequency band of 56 ch for 10 seconds, respectively, according to the set measurement condition. The sensors 203, 204 transmit the captured packets to the server 100.

The sensors 205, 206 capture packets in the frequency band of 56 ch for 50 seconds and packets in the frequency band of 52 ch for 10 seconds, respectively, according to the set measurement condition. The sensors 205, 206 transmit the captured packets to the server 100.

The sensors 207-210 capture packets in the frequency band of 52 ch, packets in the frequency band of 56 ch, packets in the frequency band of 60 ch, and packets in the frequency band of 64 ch at 15 second intervals, respectively, according to the set measurement condition. The sensors 207-210 transmit the captured packets to the server 100.

The time width for capturing packets is arbitrary, but may be divided equally for each frequency band, such as the period of capture of sensors 207-210 (15 seconds in this example). The time width may also be set based on the amount of data that can be captured.

When APs 401, 402 and sensors 201-20n are installed as shown in FIG. 7, the radio wave condition will be displayed in the display area 701, as shown in FIG. 8. Further, suppose that when sensors 201-20n (specifically, sensor 203) are moved from the position as shown in FIG. 7 to the position as shown in FIG. 9, the radio wave condition is displayed as shown in FIG. 10.

In other words, due to the fact that the sensor 203 has moved for some reason, the display of the radio wave condition changes from the state shown in FIG. 7 to the state shown in FIG. 10. However, since the APs 401 and 402 have not moved, there is no change in the actual radio wave condition. If no measures are taken, the administrator or the like may interpret that a change in the radio wave condition has occurred in the wireless communication environment 200. Then, there is a possibility that unnecessary measures such as moving APs 401, 402 will be taken.

The following explains how to estimate the position of a sensor after the movement and how to take measures. When the sensor 203 moves for some reason, the server 100 detects the movement of the sensor 203 based on information (for example, RSSI) acquired by the sensor 203, for example.

The change detection unit 224 in the sensor 203 compares the RSSI of the frequency band of 52 ch with a predetermined threshold value. The RSSI of the frequency band of 52 ch detected by the sensor 203 is lower when the sensor 203 is in the position shown in FIG. 9, compared to when the sensor 203 is in the position shown in FIG. 7. Therefore, the detection unit 102 in the server 100 can determine that the sensor 203 has moved when the RSSI added to the captured packet falls below a threshold value, for example.

It is possible that the RSSI of the frequency band of 52 ch may decrease due to the new installation of shielding in the wireless communication environment 200. In such a case, if only the RSSI of the frequency band of 52 ch is used as an indicator, it will be recognized only that the sensor 203 has left the AP 401. Therefore, in this example, the server 100 also refers to the RSSI of a frequency band (in this example, the frequency band of 56 ch) other than the frequency band of 52 ch.

The RSSI of the frequency band of 56 ch detected by the sensor 203 increases when the sensor 203 is in the position shown in FIG. 9, compared to when the sensor 203 is in the position shown in FIG. 7. Therefore, the estimation unit 103 can estimate that the sensor 203 has moved to the vicinity of the AP 402 when, for example, the RSSI added to the packet captured in the frequency band of 56 ch exceeds the threshold value. In other words, the estimation unit 103 can roughly estimate the position of the sensor 203 in the x-direction after the movement. In addition, based on the RSSI of the frequency band of 52 ch, the estimation unit 103 can estimate whether the sensor 203 is located to the right (x-coordinate value is larger relative to the AP 402) or to the left (x-coordinate value is smaller relative to the AP 402) of the AP 402.

Furthermore, in order to more reliably estimate the position of sensor 203 after the movement, specifically in the y-direction, the estimation unit 103 uses the RSSI detected by sensors 205 and 206 that capture packets transmitted and received by the STA (sensors that monitor the STA). In other words, one STA (called STAs; not shown in FIG. 11) from which the RSSI of the radio wave is detected in all of the sensors 203, 205, and 206 is focused on. Specifically, the estimation unit 103 compares the RSSI of the radio wave from the STAs detected by the sensor 205 with the RSSI of the radio wave from the STAs detected by the sensor 206. Then, the estimation unit 103 estimates the position of the sensor 203 in the y-direction according to a magnitude relationship between the RSSI of both.

In the example shown in FIG. 11, also referring to FIG. 9, the RSSI detected by sensor 205 is greater than the RSSI detected by sensor 206. In general, the RSSI value is correlated with the distance from the STA. Therefore, the estimation unit 103 can almost identify the position of sensor 203 in the y-direction based on the RSSI values of both sensors.

The condition setting unit 101 changes the measurement condition of the sensor 203 after the movement. For example, the measurement condition is changed so that the sensor 203 captures packets in the frequency band of the 56 ch for 50 seconds and captures packets in the frequency band of the 52 ch for 10 seconds.

The calculation unit 104 repeatedly generates display data to display the RSSI distribution visually (refer to FIG. 5), but if the detection unit 102 and the estimation unit 103 do not perform the above process, the RSSI distribution is generated assuming that the sensor 203 remains in the position shown in FIG. 7 even after it moves. However, in this example, after it is recognized that the position of the sensor 203 after the sensor 203 moves is such as shown in FIG. 9, the RSSI distribution is generated on the assumption that the sensor 203 exists in such a position. Thus, the possibility that a viewer to a web page may take unnecessary measures is reduced.

In the process of step S107 in FIG. 4, the condition setting unit 101 transmits the changed measurement condition to the sensor (the sensor whose measurement condition is to be changed), but until the sensor whose measurement condition is to be changed receives the changed measurement condition, the sensor transmits the data collected according to the measurement condition before the change to the server. Therefore, in the period until the sensor recognizes the changed measurement condition, an unsuitable RSSI distribution is displayed. To avoid such a situation, the calculation unit 104 in the server 100 may correct the data collected according to the measurement condition before the change based on the measurement condition after the change. Alternatively, the calculation unit 104 may discard the data received from the sensor for a predetermined period of time after the condition setting unit 101 transmits the changed measurement condition to the sensor (i.e., display based on unsuitable data is prohibited).

It is preferable that the condition setting unit 101 of the server 100 saves the changed position information as a log every time a change in the position of the sensors 201-20n is detected. It is also preferable that the condition setting unit 101 saves the changed measurement condition as a log every time the condition setting section 101 changes the measurement conditions for sensors 201-20n. It is also preferable to notify the administrator that the positions of the sensors 201-20n have been changed and that the measurement condition has been changed, for example, in a visible manner.

In the above example embodiment, it is determined whether the sensors 201-20n have moved or not based on RSSI, but it is also possible to use GPS (Global Positioning System) or indoor positioning technology to determine whether the sensors 201-20n have moved or not.

The sensors 201-20n capable of detecting the arrival direction of radio wave may be used. In that case, it may be determined whether the sensors 201-20n have moved or not based on the arrival direction of radio wave from the AP and RSSI.

When using APs that can control the emission direction of radio wave, the sensors 201-20n may be determined to have moved when it is detected that the sensors 201-20n that should exist in the emission direction of radio wave can no longer receive radio wave.

In the above example embodiment, even if the RSSI decreases due to a new installation of shielding in the wireless communication environment 200, the server 100 will determine whether the sensors 201-20n have moved or not, but when a decrease in RSSI is detected, the server 100 may generate an alarm. The administrator or the like can check the status of the devices in the wireless communication environment 200 in response to the generation of the alarm. For example, when the administrator or the like confirms the installation of the shielding, the administrator or the like does not made a change to devices in the wireless communication environment 200.

It is possible to determine whether the sensors 201-20n have moved by detecting changes in the acquired RSSI distribution images, using machine learning which uses RSSI distribution images acquired during normal operation as training data.

FIG. 12 is a block diagram showing an example of a computer having a CPU (Central Processing Unit). The computer is implemented in a wireless communication quality visualizing device or sensors 201-20n. The CPU 1000 executes processing in accordance with a program stored in a storage device 1001 to realize the functions in the above exemplary embodiment. In other words, the computer realizes functions other than wireless communication function in the sensor 201 shown in FIG. 2 (the same applies to sensors 202-20n) The computer also realizes functions other than the data storage unit 106 and the wireless communication function in the server 100 shown in FIG. 3.

The storage device 1001 is, for example, a non-transitory computer readable medium. The non-transitory computer readable medium includes various types of tangible storage media. Specific examples of the non-transitory computer readable medium include a magnetic storage media (for example, hard disk), a semiconductor memory (for example, mask ROM, PROM (Programmable ROM), EPROM (Erasable PROM), flash ROM).

The program may also be stored on various types of transitory computer readable media. The temporary computer readable medium is supplied with the program, for example, through a wired or wireless communication channel.

A memory 1002 is a storage means implemented by a random access memory (RAM), for example, and temporarily stores data when the CPU 1000 executes processing. A conceivable mode is that the program held in the storage device 1001 or in a transitory computer readable medium is transferred to the memory 1002, and the CPU 1000 executes processing on the basis of the program in the memory 1002. The data storage unit 106 shown in FIG. 3 is realized by the memory 1002 or the storage device 1001.

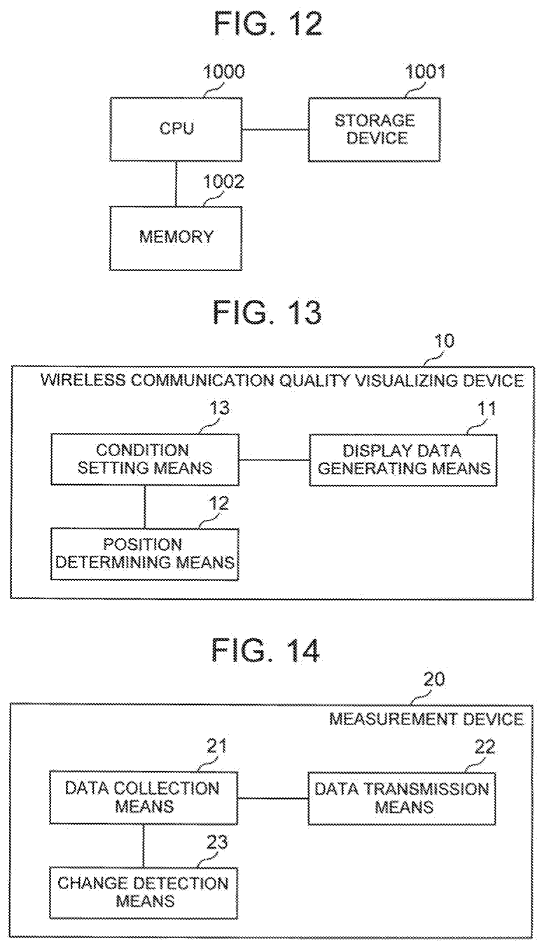

FIG. 13 is a block diagram showing the main part of the wireless communication quality visualizing device. The wireless communication quality visualizing device 10 (in the example embodiment, realized by the server 100) shown in FIG. 13 is a device that visually displays communication quality in a wireless communication environment where multiple measurement devices are installed, wherein the device 10 comprises display data generating means 11 (in the example embodiment, realized by the calculation unit 104 and the web server unit 107) for generating display data for displaying the communication quality from data on the communication quality collected by the multiple measurement devices in accordance with a measurement condition which can specify information for measuring the communication quality, position determining means (in the example embodiment, realized by the detection unit 102 and the estimation unit 103) for determining whether or not the measurement device has moved and for estimating a position of the measurement device after the movement, and condition setting means 13 (in the example embodiment, realized by the condition setting unit 101) for changing the measurement condition when the position determining means 12 determines that the measurement device has moved.

FIG. 14 is a block diagram showing the main part of the measurement device. The measurement device 20 shown in FIG. 14 is a device that is communicatively connected to a wireless communication quality visualizing device that visually displays communication quality in a wireless communication environment, wherein the device 20 comprises data collection means 21 (in the example embodiment, realized by the packet capture unit 223) for collecting data on communication quality in accordance with a measurement condition which can specify information for measuring the communication quality, and data transmission means (in the example embodiment, realized by the transmitter-receiver 221) for transmitting the data collected by the data collection means 21 to the wireless communication quality visualizing device, wherein the measurement condition includes at least information indicating a frequency band to be monitored among multiple frequency bands that can be used in the wireless communication environment, and the measurement device 20 further comprises change detection means 23 (in the example embodiment, realized by the change detection unit 224) for deciding to change the frequency band to be monitored when a condition for changing a monitoring target is satisfied.

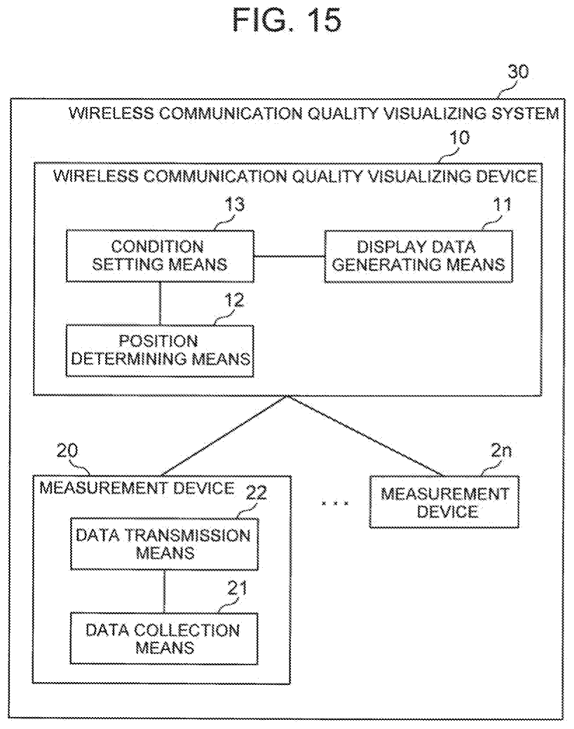

FIG. 15 is a block diagram showing the main part of the wireless communication quality visualizing system. The wireless communication quality visualizing system 30 shown in FIG. 15 is a system that visually displays the communication quality in a wireless communication environment where multiple measurement devices 20-2n are installed, wherein the system comprises a wireless communication quality visualizing device 10 including display data generating means 11 (in the example embodiment, realized by the calculation unit 104 and the web server unit 107) for generating display data for displaying the communication quality from data on the communication quality collected by the multiple measurement devices in accordance with a measurement condition which can specify information for measuring the communication quality, position determining means 12 (in the example embodiment, realized by the detection unit 102 and the estimation unit 103) for determining whether or not the measurement device 20-2n has moved and for estimating a position of the measurement device 20-2n after the movement, and condition setting means 13 (in the example embodiment, realized by the condition setting unit 101) for changing the measurement condition when the position determining means 12 determines that the measurement device 20-2n has moved, wherein each of the multiple measurement devices 20-2n includes data collection means 21 (in the example embodiment, realized by the packet capture unit 223) for collecting data on communication quality in accordance with the measurement condition, and data transmission means (in the example embodiment, realized by the transmitter-receiver 221) for transmitting the data collected by the data collection means 21 to the wireless communication quality visualizing device 10.

While the present invention has been described with reference to the example embodiment, the present invention is not limited to the aforementioned example embodiment. Various changes understandable to those skilled in the art within the scope of the present invention can be made to the structures and details of the present invention.

This application claims priority based on Japanese Patent Application No. 2019-042494 filed on Mar. 8, 2019, the disclosures of which are incorporated herein in their entirety.

### REFERENCE SIGNS LIST

10 Wireless communication quality visualizing device
11 Display data generating means
12 Position determining means
13 Condition setting means
20-2n Measurement device
21 Data collection means
22 Data transmission means
23 Change detection means
30 Wireless communication quality visualizing system
100 Server
101 Condition setting unit
102 Detection unit
103 Estimation unit
104 Calculation unit
105 Transmitter-receiver
106 Data storage unit
107 Web server unit
200 Wireless communication environment
201-210, 20n Sensor (measurement device)
221 Transmitter-receiver
222 Measurement condition setting unit
223 Packet capture unit
224 Change detection unit
401, 402 AP (access point)
500 Viewing terminal
501 Operation unit
502 Display data requesting unit
503 Display unit
1000 CPU
1001 Storage device
1002 Memory

What is claimed is:

1. A wireless communication quality visualizing device that visually displays communication quality in a wireless communication environment where multiple measurement devices are installed, comprising:
a display data generating unit which generates display data for displaying the communication quality from data on the communication quality collected by the multiple measurement devices in accordance with a measurement condition which can specify information for measuring the communication quality,
a position determining unit which determines whether or not the measurement device has moved and for estimating a position of the measurement device after the movement, and
a condition setting unit which changes the measurement condition when the position determining unit determines that the measurement device has moved.

2. A measurement device that is communicatively connected to a wireless communication quality visualizing device that visually displays communication quality in a wireless communication environment, comprising:
a data collection unit which collects data on communication quality in accordance with a measurement condition which can specify information for measuring the communication quality, and
a data transmission unit which transmits the data collected by the data collection unit to the wireless communication quality visualizing device,
wherein the measurement condition includes at least information indicating a frequency band to be monitored among multiple frequency bands that can be used in the wireless communication environment, and
the measurement device further comprises a change detection unit which decides to change the frequency band to be monitored when a condition for changing a monitoring target is satisfied.

3. The measurement device according to claim 2, further comprising:
a measurement condition setting unit which changes the measurement condition based on the fact that the change detection unit decides to change the frequency band to be monitored.

4. The measurement device according to claim 2, wherein
the change condition is that a radio wave in a frequency band other than the frequency band to be monitored is detected or that an amount of data collected in the frequency band to be monitored falling below a predetermined threshold.

5. The measurement device according to claim 2, wherein
the wireless communication environment includes multiple access points in a wireless LAN, and
the measurement condition includes information indicating the frequency band to be monitored among multiple frequency bands that can be used by the multiple access points.

6. The measurement device according to claim 5, wherein
the measurement condition includes monitoring time for each of multiple frequency bands used by the access point.

7. A wireless communication quality visualizing system that visually displays the communication quality in a wireless communication environment where multiple measurement devices are installed, comprising:
a wireless communication quality visualizing device including;
a display data generating unit which generates display data for displaying the communication quality from data on the communication quality collected by the multiple measurement devices in accordance with a measurement condition which can specify information for measuring the communication quality,
a position determining unit which determines whether or not the measurement device has moved and for estimating a position of the measurement device after the movement, and
a condition setting unit which changes the measurement condition when the position determining unit determines that the measurement device has moved,
wherein
each of the multiple measurement devices includes;
a data collection unit which collects data on communication quality in accordance with the measurement condition, and
a data transmission unit which transmits the data collected by the data collection unit to the wireless communication quality visualizing device.

8. The wireless communication quality visualizing system according to claim 7, wherein
the measurement condition includes at least information indicating a frequency band to be monitored among multiple frequency bands that can be used in the wireless communication environment, and
the measurement device includes a change detection unit which decides to change the frequency band to be monitored when a condition for changing a monitoring target is satisfied.

9-10. (canceled)

11. The measurement device according to claim 3, wherein
the change condition is that a radio wave in a frequency band other than the frequency band to be monitored is detected or that an amount of data collected in the frequency band to be monitored falling below a predetermined threshold.

12. The measurement device according to claim 3, wherein
the wireless communication environment includes multiple access points in a wireless LAN, and
the measurement condition includes information indicating the frequency band to be monitored among multiple frequency bands that can be used by the multiple access points.

13. The measurement device according to claim 4, wherein
the wireless communication environment includes multiple access points in a wireless LAN, and
the measurement condition includes information indicating the frequency band to be monitored among multiple frequency bands that can be used by the multiple access points.
